(19) United States
(12) Patent Application Publication
(10) Pub. No.: US 2017/0287332 A1
(43) Pub. Date: Oct. 5, 2017

(54) METHOD AND DEVICE FOR MONITORING A TRAFFIC SPACE

(71) Applicant: Robert Bosch GmbH, Stuttgart (DE)

(72) Inventors: Alberto Ranninger Hernandez, Alcobendas Madrid (ES); Felipe Fernandez Hernandez, Madrid (ES); Folko Flehmig, Stuttgart (DE); Miguel Angel Granda Trigo, Madrid (ES); Roland Galbas, Ludwigsburg (DE)

(21) Appl. No.: 15/512,866

(22) PCT Filed: Aug. 4, 2015
(86) PCT No.: PCT/EP2015/067959

§ 371 Date: Mar. 21, 2017

(30) Foreign Application Priority Data
Sep. 23, 2014 (DE) 10 2014 219 165.3

(51) Int. Cl. G08G 1/16; B60W 30/09

(52) U.S. Cl. CPC G08G 1/163; G08G 1/166; B60W 30/09; B60W 50/14

(57) ABSTRACT

A method for monitoring a traffic space, the method including a step for reading in, a step for ascertaining, a step for comparing, and a step for supplying. In the step of reading in, an item of positional information and/or a movement vector of a rod user within the traffic space is/are read in. In the step of ascertaining, a future position of the road user within the traffic space is ascertained using the item of positional information and/or the movement vector. In the step of comparing, the future position is compared with an item of risk information. The item of risk information represents at least one dangerous area of the traffic space. In the step of supplying, a warning signal is supplied on the basis of a result of the comparison.

### BACKGROUND INFORMATION

The present invention relates to a method for monitoring a traffic space, to a corresponding device and to a corresponding computer program.

German Patent Application No. DE 10 2008 049 824 A1 describes a method for collision avoidance.

### SUMMARY

The present invention provides, e.g., a method for monitoring a traffic space, as well as a device that uses this method and finally, a corresponding computer program. Advantageous refinements are described herein.

A future position of a road user is able to be predicted if a current position of the road user is known and if the direction in which the road user is heading is known. If the future position lies in an area that is defined as dangerous, then the road user can be warned before entering the dangerous area. This gives the road user time to adapt his behavior in order not to enter the dangerous area. Optionally, the road user may be assisted in avoiding the dangerous area.

A method for monitoring a traffic space is provided, the method having the following steps:

Reading in an item of positional information and/or a movement vector of a road user within the traffic space;

Ascertaining a future position of the road user within the traffic space using the item of positional information and/or the movement vector;

Comparing the future position with an item of risk information, the item of risk information representing at least one dangerous area of the traffic space; and

Supplying a warning signal on the basis of a result of the comparison.

A traffic space may be understood as a public space that is designed for use by motor vehicles, vehicles operated by muscle power, and pedestrians. For example, the traffic space may include roads, bicycle paths, sidewalks and squares. In the same way, the traffic space may encompass traffic-calmed zones. In particular, the method described here makes it possible to monitor the traffic space in an environment of a specific road user. A road user could be a pedestrian, a bicyclist, a horseback rider, a car, a truck or something similar. An item of positional information may represent an absolute position of the road user in relation to a reference point. An item of positional information may also represent a relative position between two road users. A movement vector can encompass an item of speed information or its derivations, and/or an item of directional information. A future position may be a position of the road user that is expected following a time step. The future position is able to be extrapolated. The future position may be estimated with a probability. The future position may be an area within which the road user is expected to be present with a high degree of probability. An item of risk information may represent a current danger at specific locations or areas of the traffic space. For example, the danger may be a statistical danger. It is possible that accidents have already occurred at the location in the past. The danger may also be a current danger because another road user, in particular stronger road user, will pass through said location in the near future. A warning signal is able to trigger a warning for the road user.

The method may have a step of ascertaining the item of risk information; in this step the item of risk information is determined using an additional future position of at least one other road user. The item of risk information may currently be ascertained. Thus, the item of risk information is able to represent the actual danger for the road user. For example, the item of risk information may represent a lower risk if the distance from a vehicle on a road is great. If the vehicle reduces the distance, it is possible to immediately update the item of risk information.

The positional information and/or the movement vector may be read in via an interface to a navigation unit of a mobile device. The method introduced here is able to be implemented as an application on a mobile telephone. Thus, a multitude of users may lead to high information density. The positional information and/or the movement vector may also be read in via an interface to at least one mobile device from the environment of the road user. A network for monitoring the traffic space is then able to be formed.

The method may include a step of verifying the positional information and/or the movement vector. Here, the item of positional information and/or the movement vector is/are verified using an independently detected position and/or movement of the road user. The detection of the road user may take place at least twice, independently of each other. The positional information and/or have a smaller deviation from each other if they are detected on the same road user. If different road users are involved, the resulting agreement is lower.

The warning signal is able to be supplied via an interface to a mobile device of the road user. The warning signal can be output via a human-machine interface of the mobile device. For example, a signal tone may be emitted if the road user is at risk. The warning signal is also able to be transmitted to a mobile device in the environment of the road user, so that another road user can be warned.

The warning signal may be developed to restrict at least one function of the mobile device while the road user is located within the dangerous area. This makes it possible to focus the attention of the road user on the road traffic.

A route suggestion for avoiding the dangerous area may be provided with the warning signal. For example, an alternative route may have less traffic. This allows for smoothing of a traffic situation.

In addition, a device for monitoring a traffic space is introduced, the device having the following features:

A device for reading in an item of positional information and/or a movement vector of a road user within the traffic space;

A device for ascertaining a future position of the road user within the traffic space using the item of positional information and/or the movement vector;

A device for comparing the future position with an item of risk information, the item of risk information representing at least one dangerous area of the traffic space; and

A device for supplying a warning signal based on a result of the comparison.

In the case at hand, a device may be understood as an electrical device that processes sensor signals and outputs control and/or data signals as a function of such processing. The device may have an interface, which is developed in the form of hardware and/or software. In a hardware development, the interfaces may be part of what is termed a system ASIC, for example, which encompasses a variety of different functionalities of the device. However, it is also possible for the interfaces to be separate integrated switching circuits or to be at least partially made up of discrete components. In the case of a software implementation, the interfaces may be software modules that are provided on a microcontroller in addition to other software modules, for example.

Also advantageous is a computer program product or a computer program having program code, which may be stored on a machine-readable carrier or memory medium such as a semiconductor memory, a hard-disk memory or an optical memory, and which is used for carrying out, implementing and/or actuating the steps of the present method according to one of the afore-described specific embodiments, in particular when the program product or the program is executed on a computer or a device.

The present invention is explained in greater detail by way of example below on the basis of the figures and example embodiments.

### BRIEF DESCRIPTION OF THE DRAWINGS

FIG. 1 shows a block diagram of a device for monitoring a traffic space according to a specific embodiment of the present invention.

FIG. 2 shows an illustration of a plurality of road users in a traffic space which is monitored by a method for monitoring according to an exemplary embodiment of the present invention.

FIG. 3 shows an illustration of a system for monitoring a traffic space according to an exemplary embodiment of the present invention.

FIG. 4 shows a reference diagram of the components of a system for monitoring a traffic space according to an exemplary embodiment of the present invention.

FIG. 5 shows intensity-distance characteristic curves of two different frequency bands according to an exemplary embodiment of the present invention.

FIG. 6 shows a flow diagram of a method for monitoring a traffic space according to an exemplary embodiment of the present invention.

FIG. 7 shows an illustration of a method sequence of a method for monitoring a traffic space according to an exemplary embodiment of the present invention.

### DETAILED DESCRIPTION OF EXAMPLE EMBODIMENTS

In the following description of advantageous exemplary embodiments of the present invention, the same or similar reference numerals are used for similarly acting elements shown in the various figures, and a repeated description of these elements is omitted.

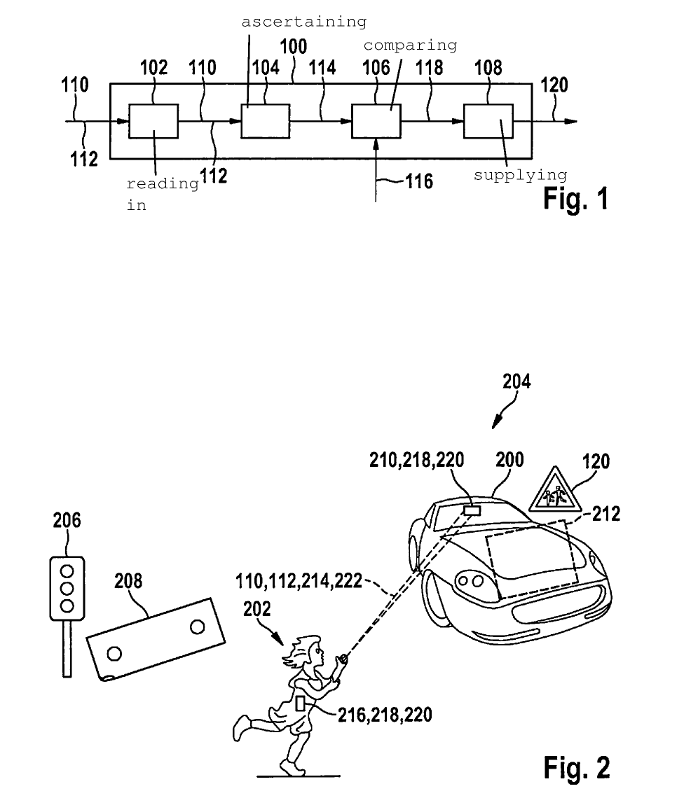

FIG. 1 shows a block diagram of a device 100 for monitoring a traffic space according to an exemplary embodiment of the present invention. Device 100 includes a device 102 for reading in, a device 104 for ascertaining, a device 106 for comparing, and a device 108 for supplying. Device 102 for reading in is adapted for reading in an item of positional information 110 or alternatively or additionally, a movement vector 112 of a road user within the traffic space. Device 104 for ascertaining is adapted for ascertaining a future position 114 of the road user within the traffic space using an item of positional information 110 and alternatively or additionally, movement vector 112. Device 106 for comparing is adapted for carrying out a comparison of future position 114 with an item of risk information 116. Item of risk information 116 represents at least one dangerous area of the traffic space. Device 108 for supplying is adapted for supplying a warning signal 120 based on a result 118 of the comparison.

FIG. 2 shows an illustration of a plurality of road users 200, 202 in a traffic space 204, which is monitored by a method for monitoring according to an exemplary embodiment of the present invention. A first road user 200 is represented here by a vehicle 200. A second road user 202 is represented by a child 202. Both road users 200, 202 are moving within traffic space 204. Vehicle 200 is traveling on a road, and child 202 is currently walking in the area of a sidewalk. However, child 202 is running in the direction of the road, which means there is a risk that child 202 may end up in front of moving vehicle 200.

Traffic space 204, for example, includes infrastructure objects 206, 208, which in an exemplary embodiment of the method introduced here are used for transmitting information about a looming danger to at least one of road users 200, 202 to road users 200, 202.

In the exemplary embodiment illustrated, vehicle 200 includes a radio-based detection system 210. A plurality of antennas 212, which are able to emit and receive electromagnetic signals 214, is installed in vehicle 200 for this purpose. Since antennas 212 are spatially distributed across vehicle 200, a position of a signal source 216 of signal 214 relative to vehicle 200 is able to be calculated from run-time differences of a signal 214 received at a plurality of antennas 212. In this regard, detection system 210 is not restricted to objects that are situated within a direct line of sight to vehicle 200. Because the detection takes place via radio waves 214, even objects that are hidden are able to be detected.

Here, child 202 is equipped with a device 216, which is developed as a signal source 216. For example, a radio reflector 216, which is adapted to a frequency of signal 214, is sewn into the clothing of child 202. In the same way, radio reflector 216 may be implemented as a removable clip that is fastened to the clothing of child 202.

Since mobile telephones have come into widespread use, a mobile telephone 216 of child 202 may serve as signal source 216. Here, signal 214 is received by at least one antenna of mobile telephone 216, processed internally, and sent back via the antenna to antennas 212 of vehicle 200.

In addition, vehicle 200 has a global satellite navigation system 218. A position of vehicle 200 within traffic space 204 is able to be determined in a highly precise manner via global satellite navigation system 218. To improve the position determination, vehicle 200 is equipped with inertial sensors 220. Because of inertial sensors 220, the position of vehicle 200 is able to be located through dead reckoning even if satellite navigation system 218 provides only a limited positional accuracy. Since the position of vehicle 200 within traffic space 204 is known on account of the use of satellite navigation system 218 and inertial sensors 220, an absolute position of child 202 within traffic space 204 is able to be detected with the aid of the relative position of child 202. Thus, the absolute position of child 202 can be located on a digital map of traffic space 204, for instance. It can therefore be determined whether child 202 is running from the sidewalk in the direction of the street or whether child 202 is running within a safe play area. In other words, a future position of child 202 is able to be determined. This future position is compared with dangerous areas in traffic space 204 in order to detect a danger to child 202 and/or vehicle 200. Here, the dangerous area is defined by a future position or by a probable driving envelope of vehicle 200. If child 202 were to continue running and thereby reach the driving envelope, there is an acute risk that child 202 would be struck by vehicle 200. This risk is reported to a driver of vehicle 200 by a warning signal 120 so that the driver is able to respond to the danger.

In one exemplary embodiment, detection system 210 operates in a frequency range that provides for a large range for detecting signal sources 216. This frequency is a low-frequency range, in particular. When signal source 216, e.g., a mobile telephone, is active, signal source 216 emits not only signal 214 but also additional information 222 in a different frequency range that has a lower range. This frequency range is a high-frequency range, in particular. The additional information 222, for example, may be an item of positional information 110 and/or a movement vector 112 of signal source 216. The item of positional information 110 and/or movement vector 112 may be detected by inertial sensors 220 of mobile telephone 216 and alternatively or additionally, by a satellite navigation system 218 of mobile telephone 216.

To improve the monitoring accuracy of traffic space 204, additional information 222 is analyzed inside vehicle 200. For example, item of positional information 110 and/or movement vector 112, which were ascertained by mobile telephone 216, are compared to the position and/or the movement of child 202 as detected by detection system 210. This increases the detection accuracy of the system as a whole.

In one exemplary embodiment, infrastructure objects 206, 208 include transmit units 216 and/or receive units 216 for at least one of signals 214 of detection unit 210. Since infrastructure objects 206, 208 are stationary, the position of vehicle 200 is able to be determined in a highly precise manner based on the ascertained relative position of vehicle 200 in relation to infrastructure objects 206, 208. Via transmit units 216 and/or receive units 216 of infrastructure 206, 208, it is also possible to exchange additional information 222. Information 222 may be exchanged both between mobile signal sources 216 and infrastructure objects 206, 208 and between vehicle 200 and infrastructure objects 206, 208. In other words, signal sources 216 in conjunction with detection device 210 form a data network.

In an exemplary embodiment, the approach presented here is implemented using an application for pedestrian protection. Here, the fact is utilized that hotspots for pedestrian accidents are in accident databases (such as GIDAS) and other sources.

Current smartphones 216 are able to accurately ascertain the position of a pedestrian 202 by dead reckoning using GPS 218, magnetic field sensors and/or acceleration sensors 220; they can also determine whether the pedestrian is running, walking or standing.

Via an application, a warning (tone, vibration) of pedestrian 202 is implemented when the pedestrian attempts to cross the street at a location with a high accident risk.

In one exemplary embodiment, an alternative, safer walking path that avoids accident hotspots is recommended.

If the pedestrian crosses a road, in particular, at an accident hotspot, no calls are connected by smartphone 216, the music is turned off and/or the use of smartphone 216 is generally blocked in order to heighten the attention of pedestrian 202.

In other words, the approach described here provides for an active protection of at-risk road users 200, 202, in particular pedestrians 202, bicyclists and car drivers 200, with the aid of a hybrid system with radio multi-frequency communication and location identification and/or micro-electromechanical system sensors 220.

An important traffic problem is illustrated by statistics of traffic-accident data. There is a high rate of death and injury among pedestrians 202, which means there is an increased societal interest in pedestrian protection.

In the avoidance of accidents of at-risk road users 202, the trend is toward active safety systems and passive safety systems for pedestrian protection.

The main goal is the active protection of at-risk road users 200, 202 through the avoidance of traffic collisions; here, the focus lies especially on pedestrian accidents in cities where the maximum speed of vehicles is 50 km/h, and the average pedestrian speed lies between five and ten km/h.

Reducing traffic accidents involving unprotected road users 200, 202 is an important goal. Official statistics for 2009 indicate that each year more than 400,000 pedestrians 202 are killed in traffic accidents worldwide.

Pedestrian collisions in the increasingly more intense traffic environment take place on a daily basis. For example, 16 percent of all persons killed in road traffic in Sweden are pedestrians. In the US, 11% of all persons killed in traffic accidents are pedestrians. In Germany, it is 13%, and in China, up to 25%.

Accident statistics also make it clear again and again that in approximately 40% of all fatal pedestrian accidents the driver 200 did not see person 202 until shortly before impact. In the case of children 202, the situation is even more dramatic. According to figures of the German Federal Bureau of Statistics from 2006, 48 percent of accident victims between the ages of 6 and 14 ran into the street without paying attention to traffic. 25% of the accidents with children occur when they suddenly appear from behind an object that has obstructed the view.

Protection systems for avoiding collisions between cars and at risk road users may be classified as video systems on the basis of visible, near-infrared or far-infrared, mono and stereo video cameras, radar-based systems, LIDAR (light detection and ranging) and laser-distance measuring systems, ultrasound-based systems, approaches based on global navigation satellite systems (GNSS) (e.g., assisted GPS, Galileo, etc.), local positioning systems (LPS) or real-time location systems (RTLS)-based approaches, RFID tag-based systems and UWB-based systems or position and motion sensor systems.

The approach described here allows for potential detection, tracking, and a collision analysis of at-risk road users 200, 202 in situations where direct visual contact exists and in situations where at-risk road user 200, 202 is hidden by an object, the approach providing a great range and high localization accuracy. At-risk road users 200, 202 are able to be detected, identified and tracked under poor weather conditions such as rain or snow, or under poor light conditions. The use of active transponders 216 on at-risk road user 202 allows for a greater range in the detection, which makes it possible to accurately identify the type of at-risk road user 202. Precise additional information 222 of at-risk road users 202 such as 6D-accelerations and 3D orientation are able to be transmitted. This results in better adaptability, flexibility and robustness of the system given different traffic scenarios, vehicles 200 and at-risk road users 202. The approach introduced here provides for an adaptive functionality of the active protection systems with regard to context, status, traffic conditions and profile of at-risk road user 202. A data fusion process allows the system to behave in a reliable and robust manner. Complementary MEMS sensors 220 improve the tracking of at-risk road users 202. The optional use of a global satellite navigation system 218 by at-risk road user 202 increases the availability, reliability and robustness of the corresponding system.

The optional communication via radio with traffic lights 206 at the side of the road increases the availability, reliability and robustness of the system. The system is also able to operate autonomously without the assistance of infrastructure means from the information and communications-technology field. A data-fusion approach results in a better risk estimate of collisions between vehicles 200 and weaker or at-risk road users 202. It is possible to use local positioning systems 210 featuring higher accuracy on the basis of narrowband and ultra-wideband technology.

Introduced is a system for the real-time detection, identification, localization and tracking of at-risk road users 200, 202 in area 204 of interest, with the aid of a radio-frequency-based system that is embedded in vehicle 200 and on at-risk road user 202, under LOS (line-of-sight) and NLOS (non-line-of-sight) conditions.

The relative position between vehicle 200 and at risk road users 202 is determined in vehicle 200 and is based on a radio-frequency system. The most important parameters are distance (range), horizontal angle (Azimuth), and vertical angle (elevation).

Combining radio-frequency-based local positioning system 210 and positional data that are made available and transmitted by at-risk road user 202 obtain better location accuracy.

The vehicle status vector, which is made up of speed, the acceleration in six directions in space, the three-dimensional orientation, the position of global satellite navigation system 218, the steering-wheel position and the position of the turn signal indicator, is evaluated.

The future vehicle path is estimated with the aid of the steering-wheel position, the setting of the turn signal indicator, the road and restrictions imposed by the sidewalk.

The status of at-risk road users 202 is analyzed within vehicle 200 while taking the 6D acceleration, the 3D orientation, and the position of the global satellite navigation system into account. For example, pedestrian states such as standing, walking, running, and pacing up and down the sidewalk are able to be detected. The use of an acceleration sensor 220 makes it possible to detect thrusts of the feet, which may be used for detecting the types of gaits of pedestrians 202.

The positional information of vehicle 200 and at-risk road user 202 from local positioning system 210 and from global satellite navigation system 218 as well as the matching map information are used for the navigation and for the related risk analysis.

In the case of unclear situations, an analysis of the global features of groups of at-risk road users 202 is able to be achieved.

An improved orientation estimate and movement estimate of at-risk road users 202 is obtained by a supplementary data fusion of 3D acceleration sensor 220, 3D gyroscope, 3D compass, pressure sensor and the position of global satellite navigation system 218. This information is transmitted to vehicle 200 via radio 214.

The position estimate of at-risk road users 202 may be improved by using additional vehicle sensors such as video, radar, lidar, ultrasonic or radio-ultrasonic systems.

Profile information such as age, personal status or physical handicap of at-risk road user 202 may be transmitted to vehicle 200 in order to improve the risk evaluation and the actuation strategy.

Additional status information such as the physical state or the likely degree of inebriation of at-risk road user 202 is able to be transmitted to vehicle 200 in order to improve the accident-risk evaluation.

Context information about at-risk road users 202, such as children in the vicinity of a school or unusual events, may be transmitted to vehicle 200 in order to improve the movement prediction and can be taken into account in the risk evaluation.

Context information about vehicle 200 and the environment such as day-night state, traffic conditions, the weather or the average number of pedestrians 202 in streets 204 may be considered in the related risk evaluation.

Through a data fusion, the profile, status and context of at-risk road users 202, the driver, vehicle 200, and the environment may be used for calculating the risk estimate and the actuation strategy.

Hierarchical and multi-level process information may be used to improve context-related functions. For example, primary information such as the location, movement, time, and identity, or secondary information such as spatial context, dynamic context, temporal context, physical relationship or traffic context may be utilized.

The system encompasses an electronically scanned antenna 212 and a local positioning system 210 on the basis of a narrowband and ultra-wideband radio frequency using technology that is based on the signal propagation time and the angle of arrival.

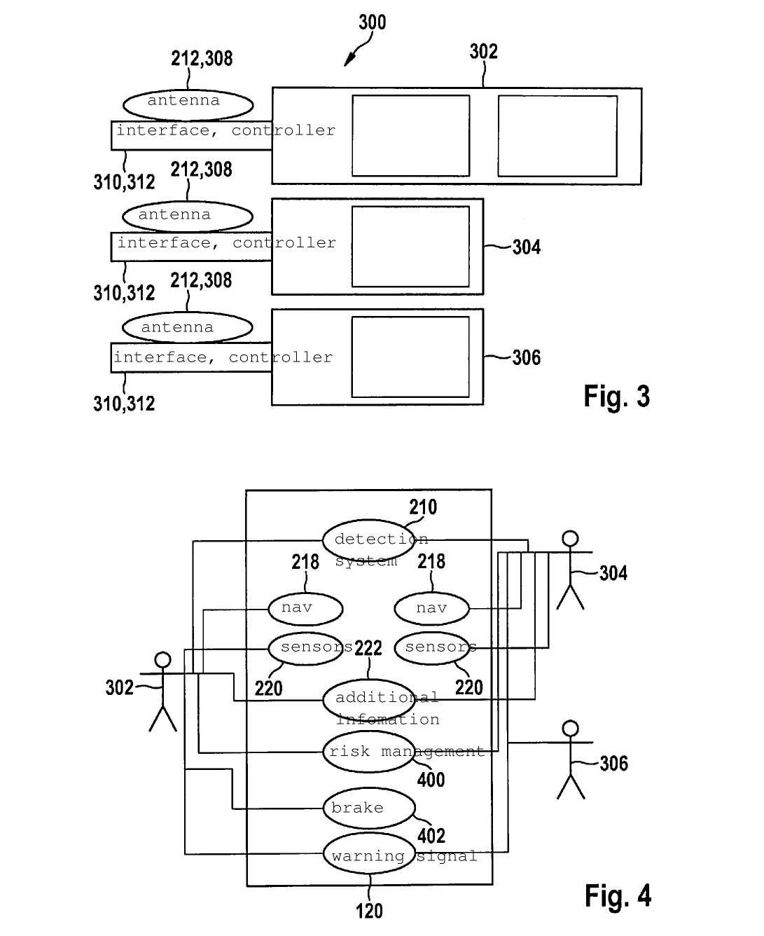

FIG. 3 shows an illustration of a system 300 for monitoring a traffic space according to an exemplary embodiment of the present invention. System 300 has at least one vehicle module 302, at least one mobile module 304, and at least one infrastructure module 306. System 300 shown here generally corresponds to the components described in FIG. 3. Each one of modules 302, 304, 306 has a first antenna 212 for a first frequency range as well as a second antenna 308 for a second frequency range. Antennas 308, 212 are connected to modules 302, 304, 306 by way of a communications interface 310 and a controller unit 312.

Vehicle module 302 includes a local position-detection system, a global satellite navigation system, a triaxial compass, a triaxial accelerometer, a triaxial yaw-rate sensor, a video camera, a radar transmitter and receiver, an RFID-position detection system, and a warning system. In addition, vehicle module 302 has a processor for merging and the work of data.

Warnings are able to be output on a human-machine interface. The vehicle module may also have actuators to allow a direct intervention in a control of the vehicle.

Mobile module 304 has a transponder, a global satellite navigation system, a triaxial compass, a triaxial accelerometer, a triaxial yaw-rate sensor, an RFID-position detection system, a warning system, as well as a battery.

Infrastructure module 306 includes a position-detection system, a camera, a radar transmitter and receiver, an RFID tag as well as a warning system.

The core of active protection system 300 for at-risk road users is a modularly distributed architecture featuring a local positioning system (LPS), micro-electromechanical system (MEMS) sensors, and possible cooperation with a global navigation satellite system (GNSS). The used multi-frequency system operates in the narrowband and in the ultra-wideband in order to enable a radio communication between vehicles and at-risk road users. In addition, cooperation with the road infrastructure is able to be implemented via radio frequency in order to manage the complexity and multitude of involved at-risk road user scenarios.

The main advantage of the approach introduced here is an increased flexibility, reliability and robustness of the corresponding active protection system for at-risk road users.

A general modularly distributed system 300 for executing the functions described here may include the following units:

An identification module, which detects and processes the static and dynamic information pertaining to at-risk road users. A communications module, e.g., based on the 802.11p communications standard. A local positioning module, e.g., based on 6 to 8.5 GHz ultra-wideband, as well as a position tracking module, such as one based on an expanded Kalman filter or a particle filter.

The following auxiliary units may be integrated in order to improve the position estimate of at-risk road users:

An inertia-measuring module, e.g., having a 3D micro-electromechanical system (MEMS) made up accelerometers and gyroscopes 3D. An orientation module, e.g., a 3D MEMS compass. A global navigation satellite system (GNSS) module, such as an A-GPS or multi-frequency Galileo, as well as a location and navigation module.

In a more complex exemplary embodiment, system 300 includes distance sensors such as a multi-beam radar or LIDAR, mono or stereo video cameras in the visible, near-infrared or far-infrared, and/or an RFID-based locating system, for instance based on passive or active anchor nodes integrated into the infrastructure. The passive anchor nodes may be 13.56 MHz HF tags, for example.

In an exemplary embodiment, system 300 encompasses a distributed processing unit, which uses the special features to carry out the corresponding data-fusion process in a manner that is adapted to the status and context of the involved actors (vehicles, pedestrians, infrastructure, and environment). An algorithm estimates the trajectories of the vehicle and the involved at-risk road users and identifies critical situations. Via radio communication, involved at-risk road users transmit data pertaining to their type, position, orientation, and inertia status. Optical and graphical warnings, e.g., in a laser head-up display, and/or sound warnings may be output in the examined human-machine interface of vehicles. In addition, the horn is activated in critical situations, and an automatic full application of the brake is optionally carried out in borderline situations. Augmented reality displays may be used to amplify the corresponding warnings. Sound and/or vibration warnings may also be implemented in the modules carried by the at-risk road users. Supplementary optical and acoustic alarms are able to be generated by signals or units of the involved infrastructure at the edge of the road, especially in a few critical traffic zones.

FIG. 4 shows a reference diagram of the components of a system 300 for monitoring a traffic space according to an exemplary embodiment of the present invention. System 300 essentially corresponds to the system in FIGS. 2 and 3. Modules 302, 304, 306 of the system are represented here by symbolic participants. Vehicle module 302 has the greatest linkage to the other modules 304, 306. Vehicle module 302 communicates with mobile module 304 via the local positioning system or detection system 210, via additional information 222 as well as warning signals 120. Vehicle module 302 communicates with mobile module 304 in a risk management 400. Infrastructure module 306 communicates via the warning signals with vehicle module 302 and mobile module 304. Vehicle module 302 and mobile module 304 access their own satellite navigation systems 218 and inertial sensors 220. In addition, the vehicle module is able to access a brake 402 of the vehicle in order to decelerate the vehicle.

An adaptive and robust hybrid system for identifying, locating and tracking is provided. A risk estimate is carried out in order to reduce traffic accidents between vehicles and at-risk road users under line-of-sight and no-line-of-sight conditions. The involved risk-evaluation functions may define automatic control actions 402. For example, a driver warning, a reduction 402 of a vehicle speed, a preparation of the mechanical brake 402, an automatic activation of brake 402, and/or a haptic activation may take place. In the same way, an at-risk road user is able to be warned with the aid of warning signals 120 and warnings on infrastructure 306. This method may also be used for the historical and continual monitoring of risk conditions of at-risk road users in continual improvement processes.

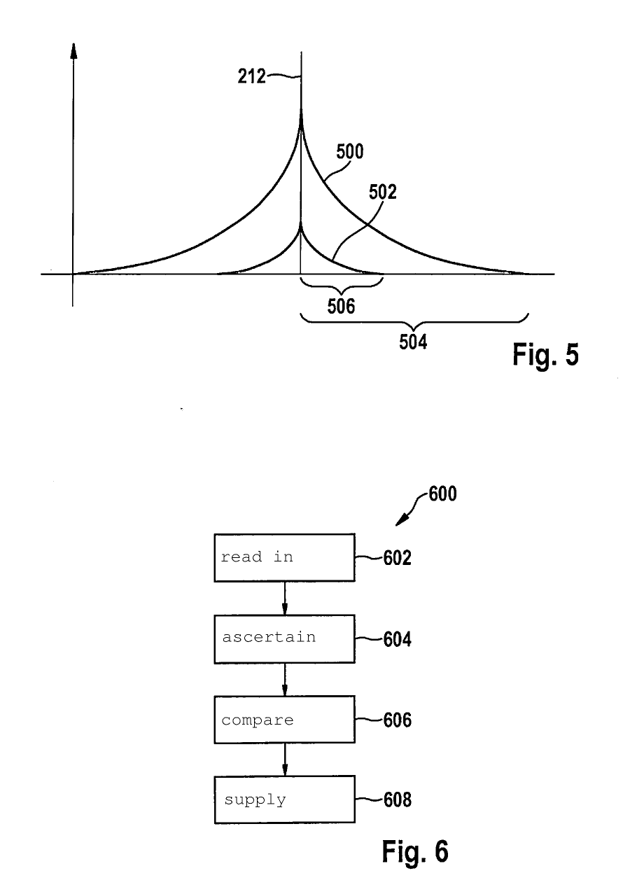

FIG. 5 shows intensity characteristic curves 500, 502 of two different frequency bands according to an exemplary embodiment of the present invention. Intensity characteristic curves 500, 502 are plotted in a diagram in which a distance in meters has been plotted on the diagram abscissa. The distance is symmetrically plotted in relation to a location of a transmitting antenna 212. A detectable signal intensity has been plotted on the ordinate. In both frequency bands the signal intensity is maximal at the location of antenna 212 and drops as the distance from antenna 212 decreases. The signal intensity drops exponentially in the process. First intensity characteristic curve 500 represents a first signal in a first frequency band having a low frequency. Second intensity characteristic curve 502 represents a second signal in a second frequency band having a higher frequency. The signal intensity of first signal 500 at antenna 212 is significantly higher than the signal intensity of second signal 502. Since both signals 500, 502 become exponentially weaker with increasing distance from the antenna, second signal 502 drops below a detectable intensity at a lower distance from antenna 212 than first signal 500. In this exemplary embodiment, first signal 500 drops below the detectable intensity at a first distance 504 of 150 meters. The second signal drops below the detectable intensity already at a second distance 506 of 50 meters.

In one exemplary embodiment, first signal 500 lies in the narrowband and is used for the exchange of information and for the rough position determination. In one exemplary embodiment, second signal 502 lies in the ultra-wideband and is used for a position determination. Second signal 502 is utilized for the transmission and reception in the driving path of the vehicle and/or in the path of the vehicle.

In one exemplary embodiment, a frequency-splitting approach is employed in which two carrier frequencies are used for different purposes. A first frequency 500 is an information frequency in the narrowband. A second frequency 502 is a positioning frequency in the ultra-wideband. Second frequency 502 is higher than first frequency 500 and is used in the pulse mode. First frequency 500 is lower than second frequency 502 and is used in the permanent mode.

In one exemplary embodiment, a wake-up mode or pulse mode is used when the information-frequency signal is available. This makes it possible to reduce interference problems in the pulse mode as well as the computational work.

In a specific embodiment, ultra-wideband (UWB) is used in order to improve the range accuracy of the local positioning system, especially in multi-path transmission scenarios.

In a specific embodiment, a Rotman lens is situated in the vehicle in order to provide a multi-beam antenna having different angular orientations with a suitable amplification and an ultra-wideband capability.

In a specific embodiment, two or more Rotman lenses are employed to provide a complementary positioning method through an angle of arrival (AOA) or time of arrival (TOA).

In a specific embodiment, the at-risk road users have a radio-frequency transmit and receive unit for the configuration, real-time information transmission and localization.

In a specific embodiment, the road users considered at risk are informed about an accident risk by the emission unit via a human-machine interface (HMI) such as a cell phone.

In a specific embodiment, a risk evaluation involving groups of at-risk road users is employed in which pedestrians in the vicinity of a traffic light or an intersection are evaluated jointly, for example.

In a specific embodiment, the real-time localization of at-risk road users is dynamically categorized into “with line-of-sight” and “without line-of-sight” in an effort to improve the identification, localization, tracking and the related risk-evaluation function.

In the event of a temporary radio-frequency occlusion of an at-risk road user, the system offers still other possibilities for tracking radio frequencies of the affected at-risk user. It is possible to use a multi-frequency system that is adapted to the examined situation. Higher or lower carrier frequencies may be employed to improve the propagation and localization via radio. The different behaviors of the different frequency signals of a radio frequency emitter may be compared during a vehicle movement. Two different carrier frequencies may be used to compare run-time differences and to enable a plausibility check. Multiple hypotheses for the propagation of radio waves can be taken into account for the tracking of the respective at-risk road users. The properties of reflected signals are able to be analyzed because they exhibit a different behavior than signals that were received directly.

FIG. 6 shows a flow diagram of a method 600 for monitoring a traffic space according to an exemplary embodiment of the present invention. Method 600 has a step 602 of reading in, a step 604 of ascertaining, a step 606 of comparing, and a step 608 of supplying. In step 602 of reading in, an item of positional information and/or a movement vector of a road user within the traffic space is/are read in. In step 604 of ascertaining, a future position of the road user within the traffic space is ascertained using the item of positional information and/or the movement vector. In step 606 of comparing, the future position is compared with an item of risk information. Here, the item of risk information represents at least one dangerous area of the traffic space. In step 608 of supplying, a warning signal is provided based on a result of the comparison.

In one exemplary embodiment, the method has a step of ascertaining the item of risk information. Here, the item of risk information is ascertained using an additional future position of at least one additional road user.

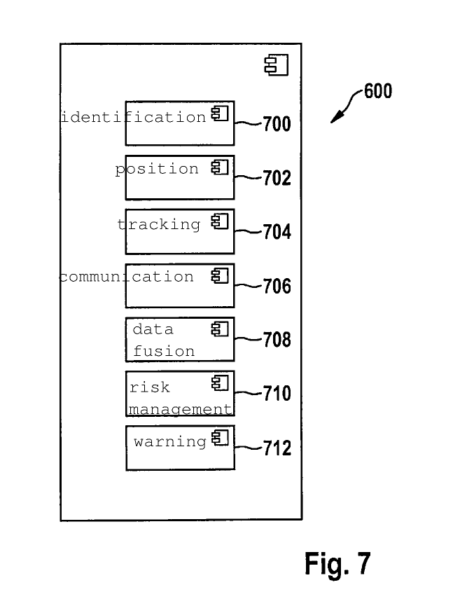

FIG. 7 shows an illustration of a method sequence of a method 600 for monitoring a traffic space according to an exemplary embodiment of the present invention. In the process, an identification 700 of an object, a position detection 702 of the object, tracking 704 of the object, a communication 706 with the object, a data fusion 708, a risk management 710, and a warning 712 via a human-machine interface take place.

The method introduced here allows for real-time tracking of at-risk road users 202 including a consideration of an inertia-measuring unit and/or an orientation-measuring unit such as a combined 3D orientation or 3D gyro and 3D acceleration.

In another application of the approach described here, systems embedded in the infrastructure are utilized for the detection and for the warning of the at-risk road users.

In a specific embodiment, infrastructure radio receiver-emitter units and other infrastructure sensors are used to collect information about at-risk road users, vehicles and the road status in order to inform about the risk by way of radio. For example, this information may be used to activate a warning lamp at a traffic light or to transmit the information via radio to vehicles or at-risk road users located in the vicinity.

In a specific embodiment, an optical and/or acoustic warning is transmitted to the driver in the event of an accident risk. Additional support by the ESP, such as a brake preparation, is possible if one potential driver reaction consists of braking. An active intervention such as braking and/or steering is possible in order to avoid accidents and/or to reduce their severity.

The exemplary embodiments described and illustrated in the figures have been selected merely by way of example. Different exemplary embodiments may be combined with one another either completely or with regard to individual features. It is also possible to supplement one exemplary embodiment with the features of another exemplary embodiment. In addition, the method steps introduced here are able to be repeated or executed in a sequence other than the one described.

If an exemplary embodiment includes an “and/or” linkage between a first feature and a second feature, then this means that the exemplary embodiment according to one specific embodiment may include both the first feature and the second feature, and according to another specific embodiment, that it may include only the first feature or only the second feature.

1-10. (canceled)

11. A method for monitoring a traffic space, the method comprising:
reading in an item of positional information and/or a movement vector of a road user within the traffic space;
ascertaining a future position of the road user within the traffic space using the item of positional information and/or the movement vector;
comparing the future position with an item of risk information, the item of risk information representing at least one dangerous area of the traffic space; and
supplying a warning signal based on a result of the comparing.

12. The method as recited in claim 11, further comprising:
ascertaining the item of risk information, the item of risk information being ascertained using an additional future position of at least one additional road user.

13. The method as recited in claim 11, wherein in reading in step, the item of positional information and/or the movement vector is/are read in via an interface to a navigation unit of a mobile device.

14. The method as recited in claim 11, further comprising:
verifying the item of positional information and/or the movement vector using an independently detected position and/or a movement of the road user.

15. The method as recited in claim 11, wherein in the supplying step, the warning signal is supplied via an interface to a mobile device of the road user.

16. The method as recited in claim 15, wherein the warning signal restricts at least one function of the mobile device while the road user is located within the dangerous area.

17. The method as recited in claim 11, wherein in the supplying step, a route proposal for avoiding the dangerous area is supplied with the warning signal.

18. A device for monitoring a traffic space, comprising:
a device for reading in an item of positional information and/or a movement vector of a road user within the traffic space;
a device for ascertaining a future position of the road user within the traffic space using the item of positional information and/or the movement vector;
a device for comparing the future position with an item of risk information, the item of risk information representing at least one dangerous area of the traffic space; and
a device for supplying a warning signal based on a result of the comparison.

19. A machine-readable memory medium on which is stored a computer program for monitoring a traffic space, the computer program, when executed on a computer, causing the computer to perform:
reading in an item of positional information and/or a movement vector of a road user within the traffic space;
ascertaining a future position of the road user within the traffic space using the item of positional information and/or the movement vector;
comparing the future position with an item of risk information, the item of risk information representing at least one dangerous area of the traffic space; and
supplying a warning signal based on a result of the comparing.
